(19) United States
(12) Patent Application Publication
(10) Pub. No.: US 2025/0211006 A1
(43) Pub. Date: Jun. 26, 2025

(54) Smart Device Charging Case

(71) Applicant: Nathan Null, Locust Grove, GA (US)

(72) Inventor: Nathan Null, Locust Grove, GA (US)

(21) Appl. No.: 18/678,454

(22) Filed: May 30, 2024

Related U.S. Application Data
(60) Provisional application No. 63/613,866, filed on Dec. 22, 2023.

(51) Int. Cl. H02J 7/00; H02J 50/10; H04B 1/3888

(52) U.S. Cl. CPC H02J 7/0044; H02J 7/0048; H04B 1/3888; H02J 50/10

(57) ABSTRACT

A smart device charging case device is provided. The device is comprised of a multifunctional smart device case designed to enhance the functionality and protection of smart devices. The device is comprised of a compartment with a locking lid for storing personal items, which can also function as a kickstand. The device is also comprised of an internal battery capable of charging the smart device wirelessly or through a direct connection. The battery also powers an LED light of the device to ensure the smart device remains visible in dark environments.

### CROSS-REFERENCE TO RELATED APPLICATION

The present application claims priority to, and the benefit of, U.S. Provisional Application No. 63/613,866, which was filed on Dec. 22, 2023, and is incorporated herein by reference in its entirety.

### FIELD OF THE INVENTION

The present invention relates generally to the field of smart device cases. More specifically, the present invention relates to a smart device charging case device that provides a charging case for a smart device that has a plurality of other functionalities. Accordingly, the present disclosure makes specific reference thereto. Nonetheless, it is to be appreciated that aspects of the present invention are also equally applicable to other like applications, devices, and methods of manufacture.

### BACKGROUND

Smartphones and other smart devices play a crucial role in our daily lives. However, maintaining these devices' battery life while on the go presents a significant challenge. Many find themselves in situations where their device's battery is running dangerously low, with no access to a power outlet. Portable chargers, often touted as a solution to this problem, are not always the most practical option. Their bulkiness can make them cumbersome to carry around, especially when one is trying to minimize their load while traveling or running errands.

Moreover, the necessity of carrying essential items such as identification, credit cards, and cash adds another layer of complexity to being on the move. While wallets have traditionally been the go-to solution for organizing and transporting these items, they are not always the preferred choice for everyone. Some individuals may find wallets too bulky or prefer not to use them for fear of losing them or having them stolen. This leads to a dilemma of how to carry these essentials in a convenient, secure, and minimalistic manner.

Additionally, the issue of misplacing or losing one's cell phone, particularly in dark environments, further exacerbates the anxiety of staying connected. It's not uncommon for individuals to experience the panic of patting down their pockets in a dimly lit room or outdoors at night, only to realize their phone is not on them. This scenario is not only stressful but can also disrupt one's plans and communications.

Therefore, there exists a long-felt need in the art for an improved case for a smart device. There also exists a long-felt need in the art for a smart device charging case device. More specifically, there exists a long-felt need in the art for a smart device charging case device that allows a user to charge their smart device easily without the need to carry a separate portable charger. In addition, there exists a long-felt need in the art for a smart device charging case device that allows a user to charge their smart device easily without the need to carry a separate portable charger and wherein said device also allows a user to carry personal items without the need for a separate wallet. Finally, there exists a long-felt need in the art for a case for a smart device that prevents a smart device from being lost or misplaced in a dark environment.

The subject matter disclosed and claimed herein, in one embodiment thereof, comprises a smart device charging case device. The device is comprised of a multifunctional smart device case designed to enhance the functionality and protection of smart devices. The device is comprised of a compartment with a locking lid for storing personal items, which can also function as a kickstand. The device is also comprised of an internal battery capable of charging the smart device wirelessly or through a direct connection. The battery also powers an LED light of the device to ensure the smart device remains visible in dark environments.

In this manner, the smart device charging case device of the present invention accomplishes all the foregoing objectives and provides an improved case for a smart device that allows a user to charge their smart device easily without the need to carry a separate portable charger. In addition, the device also allows a user to carry personal items without the need for a separate wallet. Finally, the device prevents a smart device from being lost or misplaced in a dark environment.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart device charging case device. The device is comprised of a case for a smart device such as, but not limited to, a cell phone, a tablet, etc. The device is comprised of a battery that can charge the smart device (while the device is attached to the smart device) and has a plurality of other features.

The rear surface of the body is comprised of at least one compartment that can be used to store various items such as, but not limited to, a driver's license, a credit card, a debit card, cash, etc. The compartment is comprised of at least one lid that attaches to the body via at least one hinge. The lid can be secured to the body via at least one locking member to secure valuables within the compartment. The lid can also be used as a kickstand to support the smart device in an upright position.

The body is also comprised of at least one internal battery. In a non-removable and rechargeable embodiment, the battery can be recharged via at least one charging port such as, but not limited to, a port. During use, the battery can be powered on to supply charge to a smart device within the body via at least one charging element. The charging element may include, but is not limited to, a wireless charging element or a male charging end that can be inserted into a female charging port of the smart device. The power level of the battery may be indicated by at least one indicator light positioned anywhere on the body.

The battery may also power at least one LED light positioned anywhere on the body. In one embodiment, the light is positioned on a side surface of the body. The light can be powered on/off via at least one button. The light may illuminate any color and may have a plurality of brightness levels and illumination patterns. The light allows the device (and smart device within) to be highly visible in dark environments, preventing the device and smart device from being lost/displaced.

The present invention is also comprised of a method of using the device. First, a device is provided comprised of a body comprised of at least one compartment with at least one lid, at least one battery, and at least one charging element. Then, a user can place a smart device within the body. Next, a user can open the lid, store items within the compartment, and then close the lid and secure it to the body via at least one locking member. A user can then press a button to power on the battery such that the battery provides charge to the smart device within the device via at least one charging element. A user can also open the lid at an angle and use the lid as a kickstand to support the smart device when in an upright position.

Accordingly, the smart device charging case device of the present invention is particularly advantageous as it provides an improved case for a smart device that allows a user to charge their smart device easily without the need to carry a separate portable charger. In addition, the device also allows a user to carry personal items without the need for a separate wallet. Finally, the device prevents a smart device from being lost or misplaced in a dark environment. In this manner, the smart device charging case device overcomes the limitations of existing smart device cases known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one potential embodiment of a smart device charging case device of the present invention in accordance with the disclosed architecture;

FIG. 2 illustrates a rear perspective view of one potential embodiment of a smart device charging case device of the present invention wherein the lid is being used as a kickstand in accordance with the disclosed architecture;

FIG. 3 illustrates a rear perspective view of one potential embodiment of a smart device charging case device of the present invention wherein the lid is open in accordance with the disclosed architecture;

FIG. 4 illustrates a rear perspective view of one potential embodiment of a smart device charging case device of the present invention wherein the lid is closed in accordance with the disclosed architecture;

FIG. 5 illustrates a front perspective view of one potential embodiment of a smart device charging case device of the present invention in accordance with the disclosed architecture; and

FIG. 6 illustrates a flowchart of a method of using one potential embodiment of a smart device charging case device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved case for a smart device. There also exists a long-felt need in the art for a smart device charging case device. More specifically, there exists a long-felt need in the art for a smart device charging case device that allows a user to charge their smart device easily without the need to carry a separate portable charger. In addition, there exists a long-felt need in the art for a smart device charging case device that allows a user to charge their smart device easily without the need to carry a separate portable charger and wherein said device also allows a user to carry personal items without the need for a separate wallet. Finally, there exists a long-felt need in the art for a case for a smart device that prevents a smart device from being lost or misplaced in a dark environment.

The present invention, in one exemplary embodiment, is comprised of a smart device charging case device comprised of a case for a smart device such as, but not limited to, a cell phone, a tablet, etc. The device is comprised of a battery that can charge the smart device (while the device is attached to the smart device) and has a plurality of other features.

The rear surface of the body is comprised of at least one compartment that can be used to store various items such as, but not limited to, a driver's license, a credit card, a debit card, cash, etc. The compartment is comprised of at least one lid that attaches to the body via at least one hinge. The lid can be secured to the body via at least one locking member to secure valuables within the compartment. In addition, the lid can also be used as a kickstand to support the smart device in an upright position.

The body is also comprised of at least one internal battery. In a non-removable and rechargeable embodiment, the battery can be recharged via at least one charging port such as, but not limited to, a port. During use, the battery can be powered on to supply charge to a smart device within the body via at least one charging element that may include, but is not limited to, a wireless charging element or a male charging end that can be inserted into a female charging port of the smart device. The power level of the battery may be indicated by at least one indicator light positioned anywhere on the body.

The battery may also power at least one LED light positioned anywhere on the body. In one embodiment, the light is positioned on a side surface of the body and can be powered on/off via at least one button. The light may illuminate any color and may have a plurality of brightness levels and illumination patterns. The light allows the device (and smart device within) to be highly visible in dark environments, preventing the device and smart device from being lost/displaced.

The present invention is also comprised of a method of using the device. First, a device is provided comprised of a body comprised of at least one compartment with at least one lid, at least one battery, and at least one charging element. Then, a user can place a smart device within the body. Next, a user can open the lid, store items within the compartment, and then close the lid and secure it to the body via at least one locking member. A user can then press a button to power on the battery such that the battery provides charge to the smart device within the device via at least one charging element. A user can also open the lid at an angle and use the lid as a kickstand to support the smart device when in an upright position.

Accordingly, the smart device charging case device of the present invention is particularly advantageous as it provides an improved case for a smart device that allows a user to charge their smart device easily without the need to carry a separate portable charger. In addition, the device also allows a user to carry personal items without the need for a separate wallet. Finally, the device prevents a smart device from being lost or misplaced in a dark environment. In this manner, the smart device charging case device overcomes the limitations of existing smart device cases known in the art.

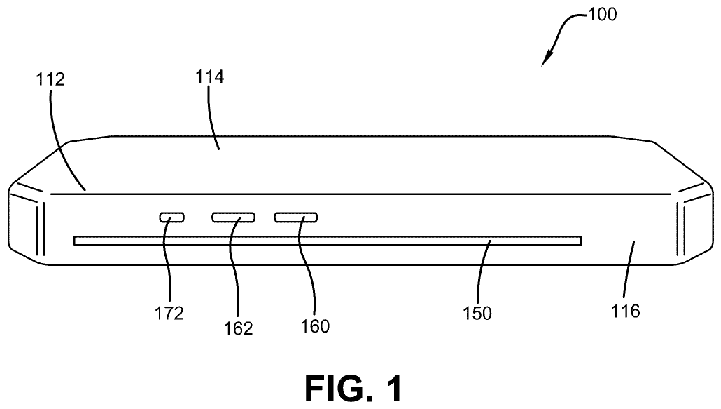

Referring initially to the drawings, FIG. 1 illustrates a side perspective view of one potential embodiment of a smart device charging case device 100 of the present invention in accordance with the disclosed architecture. The device 100 is comprised of a case for a smart device such as, but not limited to, a cell phone, a tablet, etc. The device 100 is comprised of a battery 140 that can charge the smart device (while the device 100 is attached to the smart device) and has a plurality of other features.

The body 110 may be any size, shape, and configuration in different embodiments. The body 110 may be made of any material such as, but not limited to, plastic, metal, carbon fiber, etc. The body 110 may be comprised of raised perimeter edges 112 to prevent the screen of a smart device the device 100 is attached around from impacting the ground surface and cracking/chipping if dropped. In a further embodiment, the body 110 may be comprised of at least one screen protector 114. The protector 114 may be removable or non-removable from the body 110 in different embodiments. The protector 114 may be made of any screen protector material including, but not limited to, polyethylene terephthalate, thermoplastic polyurethane, tempered glass, privacy glass, etc.

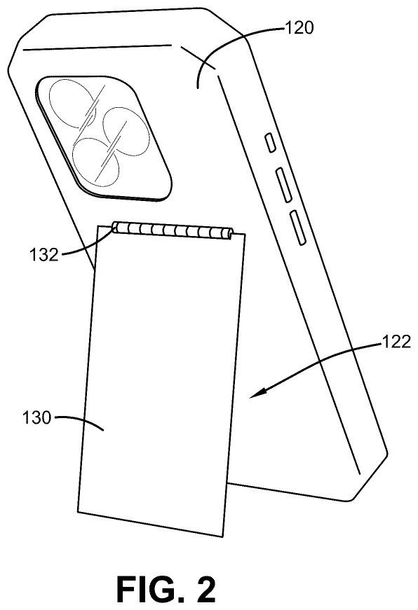

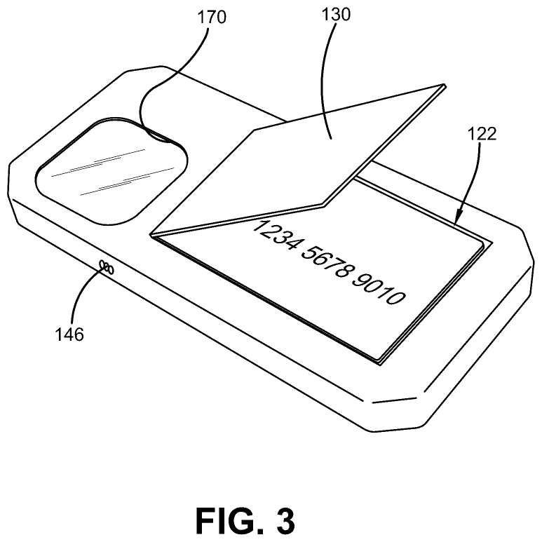

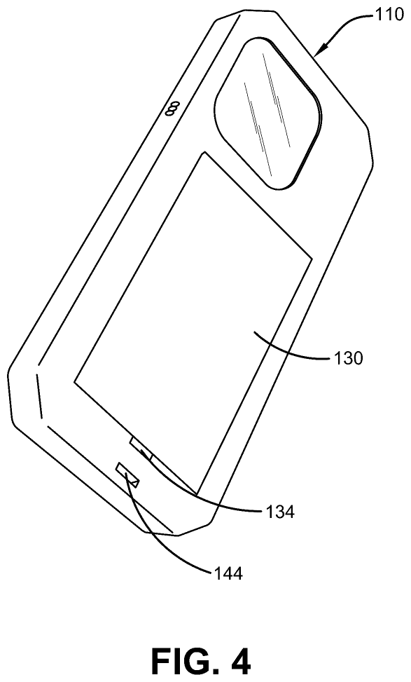

The rear surface 120 of the body 110 is comprised of at least one compartment 122. The compartment can be used to store various items such as, but not limited to, a driver's license, a credit card, a debit card, cash, etc., as seen in FIG. 3. The compartment 122 is comprised of at least one lid 130 that attaches to the body 110 via at least one hinge 132 (of any type). The lid 130 can be secured to the body 110 via at least one locking member 134 to secure valuables within the compartment 122, as seen in FIG. 4. The locking member 134 may be any type such as, but not limited to, a push lock, a snapping lock, etc. The lid 130 can also be used as a kickstand to support the smart device in an upright position, as seen in FIG. 2.

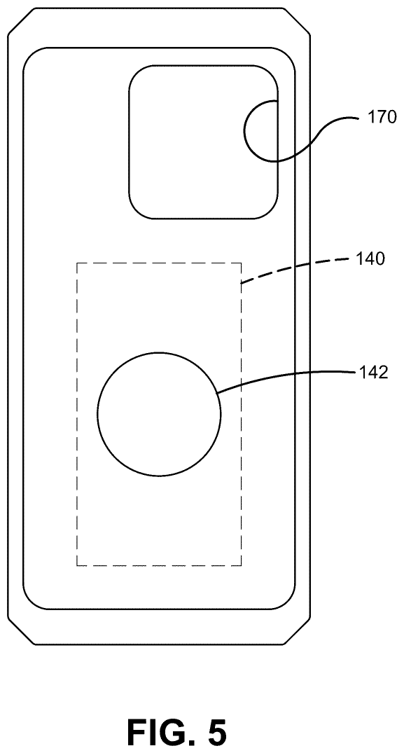

The body 110 is also comprised of at least one internal battery 140, as seen in FIG. 5. The battery 140 may be removable or non-removable and may be rechargeable or disposable. In a non-removable and rechargeable embodiment, the battery 140 can be recharged via at least one charging port 144 such as, but not limited to, a USB port. During use, the battery 140 can be powered on to supply a charge to a smart device within the body 110 via at least one charging element 142. The charging element may include, but is not limited to, a wireless charging element or a male charging end that can be inserted into a female charging port of the smart device. The power level of the battery 140 may be indicated by at least one indicator light 146 positioned anywhere on the body 110. In the preferred embodiment, there is a plurality of lights 146, wherein the amount illuminated and/or color of the lights 146 indicate the power level of the battery 140. The battery can be powered on/off via at least one button 160.

The battery 140 may also power at least one LED light 150 positioned anywhere on the body 110. In one embodiment, the light 150 is positioned on a side surface 116 of the body 110. The light 150 can be powered on/off via at least one button 162. The light 150 may illuminate any color and may have a plurality of brightness levels and illumination patterns. The light 150 allows the device 100 (and the smart device within) to be highly visible in dark environments, preventing the device 100 and the smart device from being lost/displaced.

Any portion of the body 110 may be comprised of at least one opening 170 that exposes the existing buttons, speakers, camera, etc., of the smart device that device 100 is installed around. In one embodiment, the device 100 may be comprised of a button cover 172 that is positioned atop the existing buttons of the smart device and can be depressed to activate said buttons.

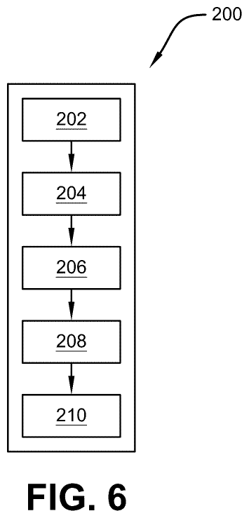

The present invention is also comprised of a method of using 200 the device 100, as seen in FIG. 6. First, a device 100 is provided comprised of a body 110 comprised of at least one compartment 122 with at least one lid 130, at least one battery 140, and at least one charging element 142 [Step 202]. Then, a user can place a smart device within the body 110 [Step 204]. Next, a user can open the lid 130, store items within the compartment 122, and then close the lid 130 and secure it to the body 110 via at least one locking member 134 [Step 206]. A user can then press a button 160 to power on the battery 140 such that the battery 140 provides charge to the smart device within the device 100 via at least one charging element 142 [Step 208]. A user can also open the lid 130 at an angle and use the lid 130 as a kickstand to support the smart device when in an upright position [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “smart device charging case device” and “device” are interchangeable and refer to the smart device charging case device 100 of the present invention.

Notwithstanding the foregoing, the smart device charging case device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the smart device charging case device 100 as shown in the FIGS. are for illustrative purposes only, and that many other sizes and shapes of the smart device charging case device 100 are well within the scope of the present disclosure. Although the dimensions of the smart device charging case device 100 are important design parameters for user convenience, the smart device charging case device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart device charging case device comprising:
a body comprised of a rear surface comprised of a compartment and a lid;
a battery;
a charging element; and
a light.

2. The smart device charging case device of claim 1, wherein the body is comprised of a removable screen protector.

3. The smart device charging case device of claim 1, wherein the body is comprised of a raised perimeter edge.

4. The smart device charging case device of claim 1 further comprised of a locking member.

5. The smart device charging case device of claim 4, wherein the locking member secures the lid to the body.

6. The smart device charging case device of claim 1, wherein the battery is comprised of a removable battery.

7. The smart device charging case device of claim 1, wherein the battery is comprised of a rechargeable battery.

8. The smart device charging case device of claim 1, wherein the charging element is comprised of a wireless charging element.

9. A smart device charging case device comprising:
a body comprised of a rear surface comprised of a compartment and a lid attached to the body with a hinge;
a battery;
a charging element; and
a light.

10. The smart device charging case device of claim 9, wherein the body is comprised of a non-removable screen protector.

11. The smart device charging case device of claim 9, wherein the body is comprised of a raised perimeter edge.

12. The smart device charging case device of claim 9 further comprised of a locking member.

13. The smart device charging case device of claim 12, wherein the locking member secures the lid to the body.

14. The smart device charging case device of claim 9, wherein the battery is comprised of a non-removable battery.

15. The smart device charging case device of claim 9, wherein the charging element is comprised of a male charging end.

16. The smart device charging case device of claim 9, wherein the light is positioned on a side surface of the body.

17. The smart device charging case device of claim 9, wherein the light illuminates a color.

18. The smart device charging case device of claim 9, wherein the body is comprised of an opening.

19. The smart device charging case device of claim 9 further comprised of an indicator light that indicates a power level of the battery.

20. A method of using a smart device charging case device, the method comprising the following steps:
providing a smart device charging case device comprised of a body comprised of a compartment with a lid, a battery, and a charging element;
placing a smart device inside the body;
opening the lid and storing an item within the compartment and then closing the lid and securing the lid to the body via a locking member; and
pressing a power button to power on the battery to provide a charge to the smart device.
